(19) United States
(12) Patent Application Publication
(10) Pub. No.: US 2006/0139240 A1
(43) Pub. Date: Jun. 29, 2006

(54) Liquid crystal display device, liquid crystal driving method and data recorder/reproducer

(75) Inventors: Toshie Oinuma, Tokyo (JP); Akira Tanaka, Tokyo (JP); Masayuki Habu, Chiba (JP)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/293,352

(22) Filed: Dec. 1, 2005

(30) Foreign Application Priority Data
Dec. 2, 2004 (JP) P2004-350483

(51) Int. Cl. G09G 3/18

(52) U.S. Cl. 345/52

(57) ABSTRACT

The present invention provides a liquid crystal display device that can regulate a visual field angle and a contrast that matches a using state. There is provided a liquid crystal display device having a plurality of scanning lines and a plurality of signal lines provided by intersecting the scanning lines and having pixel capacitors including a pixel electrode, a common electrode and a liquid crystal layer, formed at the intersecting portions of the plurality of the scanning lines and the plurality of the signal lines, which includes a common voltage regulating unit that supplies a common electrode voltage to the common electrode, a storage unit that stores a parameter for generating a common electrode voltage value for obtaining a predetermined view angel distribution for every view angle, and a control unit that controls the common electrode voltage generated by the common voltage regulating unit by selecting the parameter stored in the storage unit.

### CROSS REFERENCES TO RELATED APLILCATIONS

The present invention contains subject matter related to Japanese Patent Application JP 2004-350483 filed in the Japanese Patent Office on Dec. 2, 2004, the entire contents of which being incorporated herein by reference.

### BACKGROUND OF THE INVETION

1. Field of the Invention

The present invention relates to a liquid crystal display device and its driving method. More particularly, the present invention relates to a liquid crystal display device and a liquid crystal driving method which can change visual field angle characteristics according to a using state. Further, the present invention relates to a data recorder/reproducer which has the liquid crystal display device.

2. Description of the Related Art

A liquid crystal display, as compared with a CRT (Cathode Ray Tube), has a problem that a view angle is narrow and particularly the view angle of one direction (vertical direction, etc.) of a certain display plane is narrow. However, the problem of the liquid crystal display is improved by a technology described, for example, in Patent Document 1 (Jpn. Pat. Appln. Laid-Open Publication No. 6-194655), and, further, is solved by a technology of Patent Document 2 (Jpn. Pat. Appln. Laid-Open Publication No. 2004-191581). Demand of LCDs is increasing as the display unit of an electronic apparatus, such as a portable telephone, a portable type information processing terminal, etc.

On the other hand, with the development of so-called the Internet and the development of a large capacity recording medium, the types of data, such as data, etc., of static image data, moving image data, audio data, computer application data, etc., are diversified. Hence, the device, such as a portable telephone, a portable type information processing terminal, etc., can preferably deal with content data of more formats. For example, there is a portable telephone which is not a high performance device like a personal computer but can reproduce audio data and acquire an image by a CCD camera, etc.

### SUMMARY OF THE INVETION

The improvement of the visual field angle characteristics of the liquid crystal display is being achieved with the technology described above. However, since electronic apparatus using the liquid crystal display as a display unit are diversified. There is a case that the using state is different according to the application. For example, there is a case that the content data to be reproduced is different in the electronic apparatus, or case that user's holding way or operating process is different according to the difference of the finction of the electronic apparatus, etc. At the time, an angle of the screen perpendicular line of the liquid crystal display and that of the user's visual line are not always coincident. Accordingly, there is a problem that, even if the visual field angle to the screen perpendicular line is regulated to the wide visual field angle, the liquid crystal display does not provide a visual field range optimum for the user, depending on the application.

It is therefore desirable to provide a liquid crystal display device, a liquid crystal driving method and a data recorder/reproducer having such a liquid crystal display device, which can regulate a visual field angle and a contrast that matches a using state without using a complicated physical configuration to regulate the visual field angle by switching the visual angle characteristics of the display unit according to the using state in an electronic apparatus having different using state of the apparatus according to the kind of the content data to be reproduced.

According to the present invention, there is provided a liquid crystal display device having a plurality of scanning lines and a plurality of signal lines provided by intersecting the scanning lines and having pixel capacitors including a pixel electrode, a common electrode and a liquid crystal layer, formed at the intersecting portions of the plurality of the scanning lines and the plurality of the signal lines, including: common voltage regulating means for supplying a common electrode voltage to the common electrode; storage means for storing a parameter for generating a common electrode voltage value for obtaining a predetermined view angel distribution for every view angle; and control means for controlling the common electrode voltage generated by the common voltage regulating means by selecting the parameter stored in the storage means.

According to the present invention, there is also provided a liquid crystal driving method for a liquid crystal display device having a plurality of scanning lines and a plurality of signal lines provided by intersecting the scanning lines and having pixel capacitors including a pixel electrode, a common electrode and a liquid crystal layer, formed at the intersecting portions of the plurality of the scanning lines and the plurality of the signal lines, including: a common voltage regulating step of supplying a common electrode voltage to the common electrode; and a step of controlling the common electrode voltage generated in the common voltage regulating step by selecting a parameter necessary for generating the common electrode voltage value for acquiring a predetermined view angle distribution from a memory stored in each view angle.

According to the present invention, there is also provided a content display device for a user to observe a video displayed on a display unit in a first operation mode and a second operation mode at a different angle including: detecting means for detecting the operation mode; regulating means for regulating the view angle of the display unit; and control means for controlling the regulating means so that the display unit becomes a predetermined view angle based on the detected result of the detecting means.

According to the present invention, in the electronic apparatus having different using states of the apparatus according to the kind of the content data reproduced, the view angle and the contract to match the using state can be provided without using a complicated physical configuration for regulating the view angle by switching the visual angle characteristics of the display unit according to the using state.

### BRIEF DESCRIPTION OF THE DRAWINGS

FIG. 1 is a view for explaining the configuration of a liquid crystal display device as an embodiment of the present invention;

FIG. 2 is a view for explaining a Vcom regulating circuit in the liquid crystal display device;

FIG. 3A is a view for explaining the case that a visual field angle is set so that, when a person browsing a screen observes it from a line of sight forming a visual angle Ø to a vertical direction (Z axis) to the screen, the person can observe the screen clearly, and FIG. 3B is a view for explaining the case that, when the person observes the screen from the line of sight forming a visual angle-ρ to the vertical direction (Z axis) to the screen, the person can observe the screen clearly;

FIG. 4 is a structural view for explaining the content recorder/reproducer applied with the liquid crystal display device shown as the embodiment of the present invention;

FIG. 5 are views for explaining the appearance of the content recorder/reproducer applied with the liquid crystal display device shown as the embodiment of the present invention; FIG. 5A is a view of the content recorder/reproducer as observed from a back surface; and FIG. 5B is a view of the content recorder/reproducer as observed from a front surface;

FIG. 6 is a schematic view for explaining the state of operating the content recorder/reproducer when a user looks down an LCD panel of the display unit:

FIG. 7 is a schematic view for explaining the state of operating the content recorder/reproducer when the user looks down the LCD panel of the display unit;

FIG. 8 is a schematic view for explaining the state that the user observes the LCD panel of the display unit is mounted on a cradle; and

FIG. 9 is a flowchart showing a process of changing the view angle of the LCD panel according to the mode in the content recorder/reproducer.

### DETAILED DESCRIPTION OF THE PREFERRED EMBODIMENTS

A liquid crystal display device shown as an embodiment of the present invention will be described in detail with reference to the drawings. The liquid crystal display device 100 is finctionally divided into a liquid crystal display unit for displaying an image and a liquid crystal driver. The liquid crystal display unit is, for example, a liquid crystal panel 101 of a TFT type. On the liquid crystal panel 101, a liquid crystal display element (not shown) and an opposed electrode 102 to be described later are provided. The liquid crystal driver has a source driver 103 as a signal line driver, a gate driver 104 as a scanning line drier, a liquid crystal drive power supply 105 and a controller 106.

Further, the liquid crystal display device 100 indicated as the embodiment of the present invention includes a parameter memory 107 for storing a parameter for liquid crystal controlling to optimally regulate the view angle of the liquid crystal display unit according to the using state of the apparatus in which the positional relationship between a liquid crystal display surface and a user is changed.

The source driver 103 has a plurality of source drivers 103 made of ICs. The gate driver 104 has a plurality of gate drivers similarly made of ICs.

Each of the source driver 103 and the gate driver 104 is generally formed of, for example, TCP (Tape Carrier Package) which carries the IC chip on a film in which wiring is formed. The TCP is mounted on the ITO (Indium Tin Oxide: an indium-tin oxide film) terminal of the liquid crystal panel 101. The TCP is connected to the liquid crystal panel 101. Moreover, the above-mentioned IC chip is thermally press bonded to the ITO terminal of the liquid crystal panel 101 directly through an ACF (Anisotropic Conductive Film), connected to the liquid crystal panel 101 to be mounted, and connected to the liquid crystal panel 101.

The controller 106 inputs display data D and a control signal (start pulse SP, etc.) to the source driver 103. On the other hand, the controller 106 inputs a vertical synchronous signal VS to the gate driver 104. Further, the controller 106 inputs a horizontal synchronous signal LS to the source driver 103 and the gate driver 104.

In the liquid crystal panel 101, a pixel electrode 111, a pixel capacitor 112, a TFT 113 for controlling ON/OFF of the application of a voltage to the pixel electrode 111, a source line (signal line) 114, a gate line (scanning line) 115 and an opposed electrode (also called a common electrode) 116 are provided. The liquid crystal display element 110 for one pixel part has the pixel electrode 111, the pixel capacitor 112 and the TFT 113.

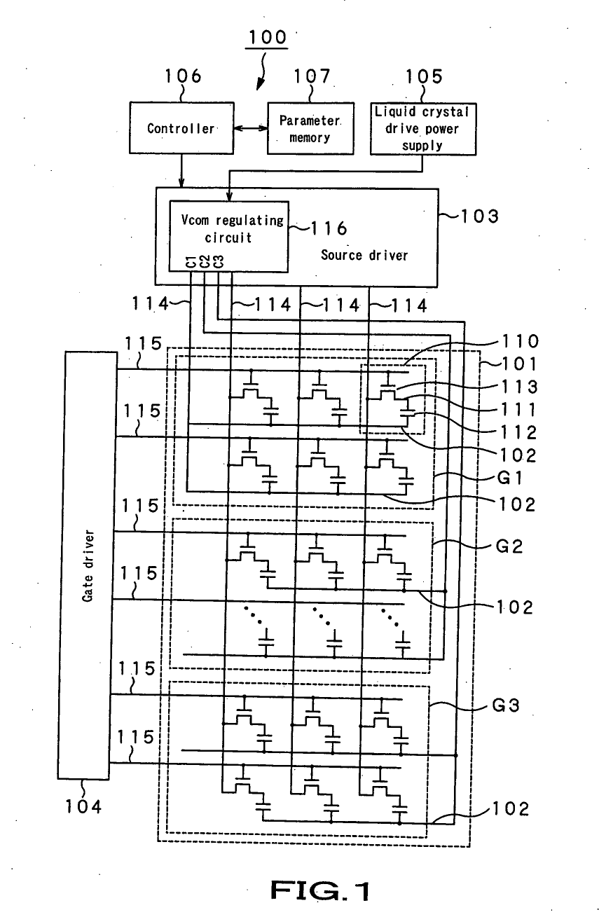

As shown in FIG. 1, the opposed electrodes 102 are divided into groups in which n gate lines (n is a positive integer) are differentiated in every k numbers. Further, each of a plurality of adjacently located gate lines is divided into groups. The opposed electrodes 102 of each group respectively have opposed electrode voltage C by the Vcom regulating circuit 116 built in the source driver 103.

For example, when all the opposed electrodes 102 of the liquid crystal panel 101 are divided into a group G1, a group G2 and a group G3, opposed electrode voltages C1, C2 and C3 are respectively applied to the opposed electrodes 102 of the groups G1 to G3 from the Vcom regulating circuit 116.

The display operation of the liquid crystal display device 100 of the above-mentioned configuration will be described. The display data inputted from outside is inputted to the source driver 103 as display data D of a digital signal through a controller. The source driver 103 divides the inputted display data D in a time division manner, latches the display data D to the respective source drivers. Thereafter, the display data D is D/A converted synchronously with a horizontal synchronous signal LS inputted from the controller 106. Then, the analog voltage (hereinafter referred to as a gradation voltage) for gradation display which is obtained by D/A converting the time divided display data D is outputted to the corresponding liquid crystal display element of the liquid crystal panel 101 through the source line 114.

The gradation voltage in response to the brightness of the pixel to be displayed is applied from the source driver 103 to the source line 114. On the other hand, scanning signals adapted to sequentially turn on the TFTs 113 aligned in a column direction are applied from the gate driver 104 to the gate line 115. The gradation voltage of the source line 114 is applied to the opposed electrode 102 connected to the drain of the TFT 113 through the TFT 113 of an ON state. Then, the gradation voltage is accumulated in the pixel capacitor 112 between the opposed electrode 102 and the pixel electrode 111. Thus, the light transmittance of the liquid crystal is changed in response to the gradation voltage for displaying pixels.

Further, in the embodiment, the opposed electrode voltages C1, C2 and C3 are respectively applied to the three sets of the opposed electrodes 102 of the first group G1, the second group G2 and the third group G3 from the Vcom regulating circuit 116 built in the source driver 103.

The liquid crystal display device 100 changes the voltage applied to the liquid crystal layer as an analog voltage. Thereby, a multiple gradation display is realized by changing the light transmittance of a liquid crystal in an analog manner. Furthermore, as described above, the liquid crystal display device 100 divides the opposed electrodes 102 into a plurality of groups G1, G2, G3,. . . , and applies the different opposed electrode voltages C1, C2, C3,. . . , to the opposed electrodes 102 of the respective groups from the Vcom regulating circuit 116 provided in the source driver 103. Thus, the luminance characteristics can be changed so as to obtain an optimum visual field in each visual angle. Moreover, a color change generated due to the difference of the visual angles can be corrected. Here, the “visual angle” means an angle formed between the line of sight and the normal of the display screen.

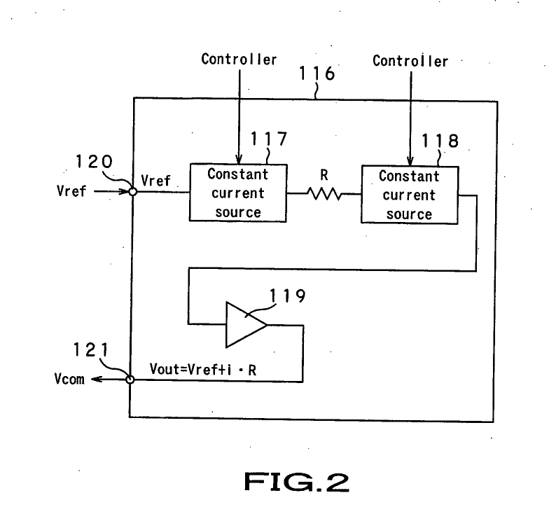

FIG. 2 is a view showing the structural example of the Vcom regulating circuit 116 provided in each source driver 103. The Vcom regulating circuit 116 has one resistive element R for generating a voltage drop, two constant current sources 117, 118, and a buffer amplifier 119. The Vcom regulating circuit 116 regulates the Vcom voltage by using the voltage drop obtained by supplying a current to the resistive element R and vertically shifting the inputted voltage by a predetermined voltage. The Vcom regulating circuit 116 having such a configuration operates as follows.

A voltage Vref becoming a reference is, for example, supplied to an input terminal 120 of the Vcom regulating circuit 116. Then, in case of obtaining an output voltage higher than the reference voltage Vref or an output voltage lower than the reference voltage Vref, the current flowing to the resistive element R is changed by the constant current sources 117, 118. Then, the voltage Vout shifted up or down for the voltage drop part of the resistive element R from the inputted voltage is outputted as the voltage Vcom from an output terminal 121, by using the voltage drop of the resistive element R.

More particularly, in case of obtaining the output voltage Vout higher than the reference voltage Vref, the Vcom regulating circuit 116 regulates the voltage so as to be Vout=Vref+i•R. Further, when obtaining the output voltage Vout lower than the reference voltage Vref, the circuit 116 regulates the voltage so as to be Vout=Vref−i·R.

When the output voltage Vout higher than the reference voltage Vref is obtained, and when the output voltage Vout lower than the reference voltage Vref is obtained, the state that the current flowing to the resistive element R is changed by the operations of the constant voltage sources 117, 118 is indicated.

When the constant voltage source 117 located at the input terminal 120 side from the resistive element R is grounded and the constant current source 118 located at the output terminal 121 side is connected to the power source. Thereby, the current i of the positive direction directed from the constant current source 118 to the constant current source 117 flows to the resistance element R. As a result, the output voltage Vout, from the output terminal 121 when the reference voltage Vref from the input terminal 120 is inputted, becomes Vout=Vref+i·R higher by the voltage drop part of the resistance element R as compared with the reference voltage Vref.

On the other hand, when the constant current source 117 is connected to the power source and the constant current source 118 is grounded, the current i of the negative direction directed from the constant current source 117 to the constant current source 118 flows to the resistive element R. As a result, the output voltage Vout from the output terminal 121 when the reference voltage Vref from the input terminal 120 is inputted becomes Vout=Vref−i·R for the voltage drop at the resistive element R as compared with the reference voltage Vref.

In each Vcom regulating circuit 116, the current value can be switched to a plurality of values in the constant current sources 117, 118. Further, the connections to the ground and the power supply can be switched. Therefore, the opposed electrode voltage can be fmely regulated by controlling the above-mentioned switching based on the regulating data (DL).

As described above, the visual field angle of the liquid crystal panel is changed according to the amplitude of the applied voltage applied to the liquid crystal. When the voltage applied to the liquid crystal is changed. The inclining angle of the liquid crystal molecules is changed, and the brightness is determined according to the inclining angle. Thus, the angle of the liquid crystal can be changed to the angle that the maximum brightness is obtained according to the amplitude of the drive voltage to be applied.

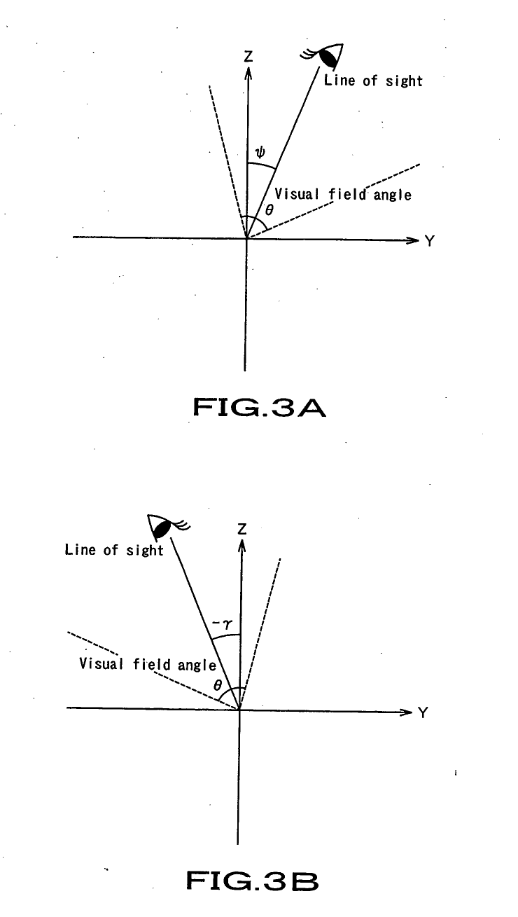

FIG. 3 is a view for explaining the case that a visual field angle distribution is regulated to a different predetermined state in the liquid crystal display device 100. When the distribution of the gradation voltage is suitably regulated, the liquid crystal display device 100 can be set to have the view angle as shown, for example, in FIG. 3A or to have the view angle as shown in FIG. 3B. FIG. 3A shows that, when a person browsing a screen observes it from a line of sight (visual axis) forming a visual angle Ø to a vertical direction (Z axis) to the screen, the screen is observed clearly. FIG. 3B shows that, when the person observes the screen from the line of sight (visual axis) forming a visual angle-ρ to the vertical direction (Z axis) to the screen, the screen is observed clearly. The liquid crystal display device 100 stores various parameters in the parameter memory 107 for controlling the Vcom value and the liquid crystal panel to become the optimum view angle to a plurality of visual angles as described above.

An electronic apparatus having the display unit is common. However, when considering the fact that the screen and the user's line of sight are not always superposed on the perpendicular line of the screen, the effect that the optimum view angle can be regulated to match the direction of the line of sight formed at the visual angle to the perpendicular direction (Z axis) of the screen by regulating the gradation voltage as described above, is very useful when the liquid crystal display device 100 is provided in the electronic apparatus and the like.

In the following, an example in which the liquid crystal display device 100 shown as an embodiment of the present invention is applied to an electronic apparatus, will be described using the drawings.

Here, as the electronic apparatus, a content recorder/reproducer which can record/reproduce content data including audio data, video data, data for a computer (hereinafter referred to as “PC data”) on a recording medium of minidisk (Registered Trademark) type is used as one example of a disc-like magnetooptical medium.

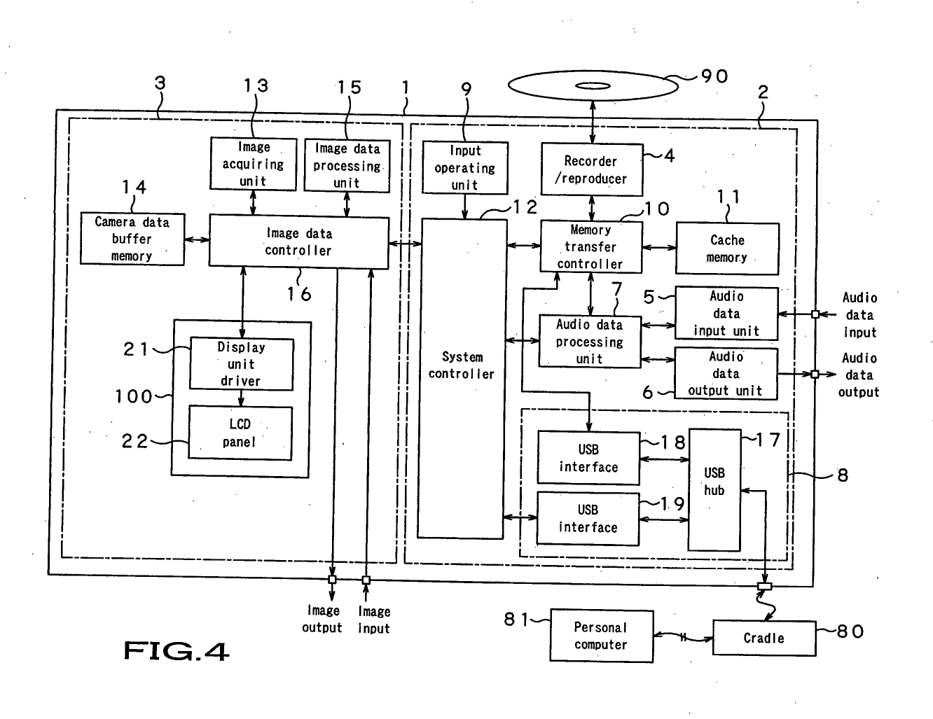

The content recorder/reproducer 1 shown in FIG. 4 applied with the present invention has a configuration as a camera and a function as an audio recorder/reproducer. The content recorder/reproducer 1 can record and reproduce photographed image data on and from the minidisk, and can record and reproduce audio data on and from the minidisk. The minidisk which can be reproduced by the content reproducer can handle different data formed in different formats, for example, audio data, video data, PC data, and the minidisk has a concealing area which can be used by an authentication, and a normal recording area which can be used without authentication. The concealing area is an area which can record only specific data, such as a music content, a video content, etc., to be copyrighted In the embodiment, the audio data of an ATRAC (registered trademark), such as an ATRAC (Adaptive Transform Acoustic Coding) type, an ATRAC3 type, and an ATRAC3plus type are handled as specific data which can be recorded on the concealing area. The data, such as audio data, image data, text data other than the ATRAC, such as MP3 (MPEGI Audio Layer-3) type, and WMA (Windows (registered trademark) Media Audio) type are recorded on a normal recording area.

The content recorder/reproducer 1 shown in FIG. 4 includes a data recorder/reproducer controller 2 and an image processing unit 3. The data recorder/reproduce controller 2 includes a recorder/reproducer unit 4 for recording/reproducing on/from a minidisk 90, an audio data input unit 5 for inputting audio data, an audio data output unit 6 for outputting audio data to outside, an audio data processing unit 7 for performing a predetermined compression/extension process to the audio data, an external interface unit 8 for transmitting/receiving data to/from an information processing apparatus, an input operating unit 9, a memory transfer controller 10, a cache memory 11 as an auxiliary memory, and a system controller 12.

The image processing unit 3 includes an image acquiring unit 13 having a CCD (Charge Coupled Device), a lens unit and the like, a camera data buffer memory 14 as a temporary storage place of the acquired image data, an image data processing unit 15 for performing a predetermined compression/extension process of the image data, and an image data controller 16 for controlling the image processing unit 3.

Moreover, the liquid crystal display device 100 having a display unit driver 21 and an LCD panel 22 is provided as the display unit. The display unit driver 21 of FIG. 4 corresponds to the source driver 103, the gate driver 104, the liquid crystal drive power supply 105, and the controller 106 shown in FIG. 1. The LCD panel 22 corresponds to the liquid crystal panel 101.

Further, the content recorder/reproducer 1 has a USB hub 17, a USB interfaces 18 and 19 as an external interface unit 8 of the data recorder/reproducer controller 2. The content recorder/reproducer 1 is connected to a cradle 80 via the external interface unit 8. Further, the content recorder/reproducer 1 can be connected, through the cradle 80 or directly, to the personal computer (hereinafter referred to as a PC) 81.

The content recorder/reproducer 1 has the configuration described above. The content recorder/reproducer 1 can record audio data and acquire image data for storing it in the minidisk 90 by using the minidisk 90 as a recording medium which can record various type content data formed with different formats. Further, the content recorder/reproducer 1 can be connected to the information processing apparatus, such as a PC, through the external interface unit 8. Thereby, the content recorder/reproducer 1 can be used as an external storage of the information processing apparatus.

The configurations shown in FIG. 1 will be hereinafter described concretely. The memory transfer controller 10 in the content recorder/reproducer 1 controls to transmit and receive reproducing data read by the recorder/reproducer 4 of a plurality of content data having different formats recorded on the minidisk 90 or recording data supplied to the recorder/reproducer 4. The memory transfer controller 10 reads the content data from the minidisk 90 designated by the user through the input operating unit 9 and controls to temporarily store the content data in the cache memory 11.

The cache memory 11 is a memory for temporarily storing the data read at a high density data cluster unit from the data track of the minidisk 90 by the recorder/reproducer 4 under the control of the above-mentioned memory transfer controller 10. The cache memory 11 stores various management information, such as UTOC data, etc., read from the minidisk 90 by the recorder/reproducer 4, information for protecting a copyright to be recorded in the concealing area, information for checking data falsification, external device information for allowing limited accessing, etc., based on the control of the memory transfer controller 10.

When the minidisk 90 is, charged in the recorder/reproducer 4, for example, the system controller 12 instructs the recorder/reproducer 4 to read the management information, etc., from the management information recording area of the minidisk 90, and stores the read management information, such as, the PTOC, UTOC, etc., in the cache memory 11 by the memory transfer controller 10. Further, the system controller 12 grasps the track recording state of the minidisk 90 by reading the management information. Furthermore, the system controller 12 can communicate with the PC 81 connected through the USB interface 19 and the USB hub 17. The system controller 12 performs the communication control to the PC 81, receives the command of a write request, read request, etc., from the PC 81, and transmits other necessary information, such as status information for the PC 81.

When there is a read request of certain FAT sector from the PC 81, the system controller 12 applies a control signal of the effect that reading of the data cluster including FAT sector requested for reading to the recorder/reproducer 4. The data cluster read by the recorder/reproducer 4 is written in the cache memory 11 by the memory transfer controller 10. However, if the data of the FAT sector is already stored in the cache memory 11, reading by the recorder/reproducer 4 is not necessary. At the time, the system controller 12 applies a control signal for reading the data of the requested FAT sector from the data of the high density data cluster written in the cache memory 11 and controls to transmit to the PC 81 through the USB interface 19 and the USB hub 17.

When there is the write request of the certain FAT sector from the PC 81, the system controller 12 makes the recorder/reproducer 4 read the data cluster including the FAT sector requested for writing. The read data cluster is written in the cache memory 11 by the memory transfer controller 10. However, if the data of the FAT sector is already stored in the cache memory 11, reading by the recorder/reproducer 4 is not necessary. Further, the system controller 12 supplies the recorded data of the FAT sector transmitted from the PC 81 to the memory transfer controller 10 through the USB interface 19, and makes the memory transfer controller 10 rewrite the data of the corresponding FAT sector in the cache memory 11. Further, the system controller 12 instructs the memory transfer controller 10 to transfer the data of the data cluster stored in the cache memory 11 in the state that the necessary FAT sector is rewritten to the recorder/reproducer 4 as the recording data. At this time, the recorder/reproducer 4 modulates the recorded data of the data cluster in the modulation type corresponding to the minidisk of the mounted recording medium and writes the data.

Incidentally, the above-mentioned recording/reproducing control is a control in the case of recording/reproducing a data track. The data transfer in the case of recording/reproducing MD audio data to be recorded and reproduced on and from the audio track is performed through the audio data processing unit 7.

Furthermore, the image data acquired by the image acquiring unit 13 is recorded on the minidisk 90 through the image data controller 16 and the system controller 19. The image data recorded on the minidisk 90 is encoded in a predetermined manner by the image data processing unit 15, and compressed. The image data read out from the minidisk 90 is reproduced by the display unit. The image data reproduced from the minidisk 90 is decoded by the image data processing unit 15, and processed to be data extension. Further, the content recorder/reproducer 1 may be configured to have an input terminal for receiving the image data from outside and an output terminal for outputting the image data to outside with respect to the image data controller 16.

As another structure of the content recorder/reproducer 1, the audio data input unit 5 has, as an input system to the audio data processing unit 7, for example, an analog audio signal input unit, such as a line input circuit/microphone input circuit, etc., an A/D converter, and a digital audio data input unit. Also, the audio data processing unit 19 has an ATRAC compression encoder/decoder, and a buffer memory of compressed data. Further, the audio output unit 6 has, as an output system to the audio data processing unit 7, for example, a digital audio data output unit, a D/A converter and an analog audio signal output unit, such as a line output circuit/headphone output circuit, etc.

A first route of recording the audio track to the minidisk 90 of the recording medium is the case when the digital audio data or the digital audio signal converted from the analog audio signal by the A/D converter of the audio data input unit 5 is inputted to the audio data processing unit 7. The inputted linear PCM digital audio data or the linear PCM audio data inputted by the analog audio signal, and then converted by the A/D converter and acquired, is ATRAC-compression-encoded, and stored in the cache memory 11. Then, the data is read at predetermined timing, such as, an ADIP cluster corresponding data unit, from the cache memory 11, and transferred to the recorder/reproducer 4. The recorder/reproducer 4 modulates the transferred compression data by an FEM modulation type or an RLL(1-7) PP modulation type, and writes the compression data in the concealing area of the minidisk 90 as an audio track.

Moreover, the second case of recording the audio track of the minidisk 90 of the recording medium is the case that the audio data allowed to be recorded in the concealing area is inputted from a personal computer 100. In the case, whether the data recorded in the minidisk 90 is the data allowed to be recorded in the concealing area is checked through the USB hub 17, the USB interface 19 between the personal computer 100 and the system controller 12. When it is recognized that the data recorded in the minidisk 90 is the data allowed to be recorded as the audio data in the concealing area of the minidisk 90, the system controller 12 instructs the recorder/reproducer 4 to record the designated audio data inputted from the personal computer 100 on the concealing area of the minidisk 90, with respect to the memory transfer controller.

When the recording in the concealing area of the minidisk 90 is allowed, the personal computer 100 transfers an audio data file to the memory transfer controller through the USB hub 17, the USB interface 18. The transferred audio data file is temporarily stored in the cache memory 11. Then, the audio data file is read from the cache memory 11 at predetermined timing, such as, ADIP cluster corresponding data unit, and transferred to the recorder/reproducer 4. In the recorder/reproducer 4, the transferred compressed data is modulated by an EFM modulation type or an RLL(1-7)PP modulation type, and written in the concealing area of the minidisk 90 as the audio track.

When the audio track recorded in the concealing area of the minidisk 90 is reproduced from the minidisk 90, the recorder/reproducer 4 demodulates the reproduced data to the ATRAC compression data state, and transfers the data to the audio data processing unit 7. The audio data processing unit 7 performs ATRAC compression decoding to the audio data reproduced and ATRAC encoded from the minidisk 90 to make it linear PCM audio data. Then, the linear PCM audio data is outputted as the digital data from the audio data output unit 6. Alternatively, the linear PCM audio data is converted into an analog voice signal by the D/A converter for line output/headphone output.

Incidentally, the connection to the PC 81 is not limited to the USB. For example, in addition to a so-called IEEE1394 interface conforming to the standards by IEEE (The Institute of Electrical and Electronics Engineers, Inc.), a general purpose connection interface can be applied.

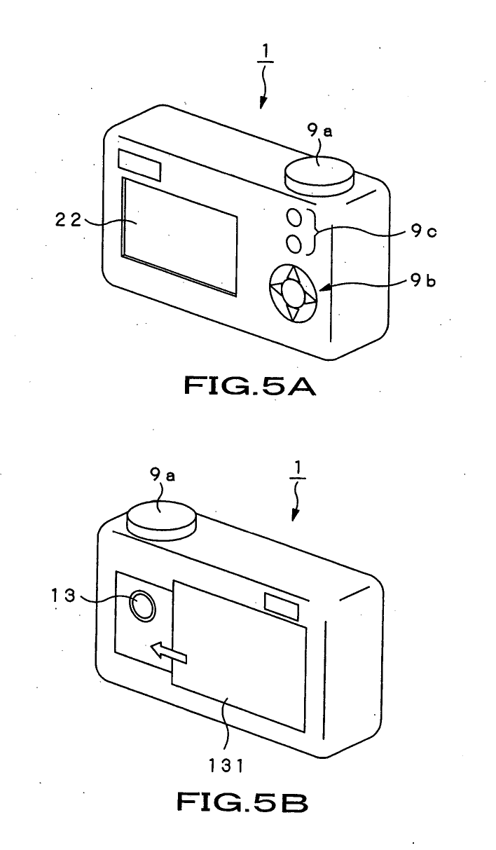

FIG. 5 shows the appearance of the content recorder/reproducer 1. The content recorder/reproducer 1 includes, as the input operating unit 9, a shutter 9a used in a camera mode, an arrow key 9b, a button 9c, etc. Further, the content recorder/reproducer 1 includes an LCD panel 22 of a display unit on its back surface. A lens for constituting the image acquiring unit 13 is exposed on the front surface. The lens is protected by a lens cover 131. The lens cover 131 is used to protect the lens and to discriminate whether it is a camera mode or an audio mode according to the opening and closing of the lens cover 131.

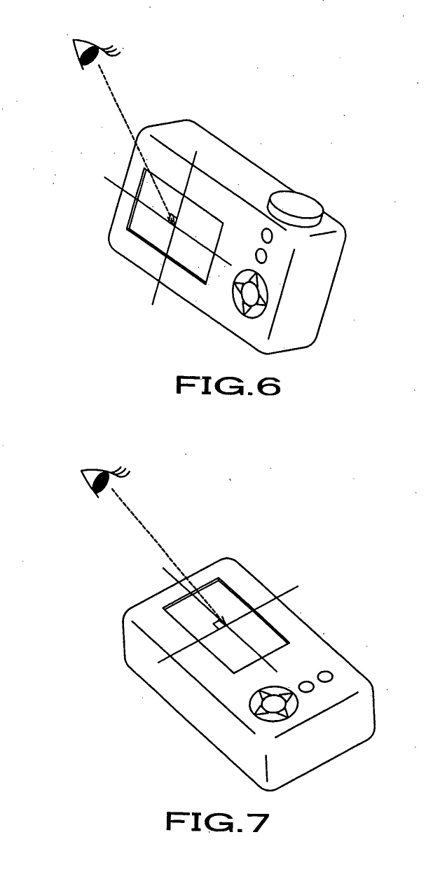

When the content recorder/reproducer 1 shown in FIG. 5 is used in the camera mode, as shown in FIG. 6, the user often operates the content recorder/reproducer 1 in the posture for looking down at the LCD panel 22, that is the display unit. Specifically, the case that the screen of the apparatus in which the vertical direction is fixed is observed at the line of sight shown in FIG. 3A. Further, when the content recorder/reproducer 1 shown in FIG. 5 is used in the audio mode, as shown in FIG. 7, the user often operates the content recorder/reproducer 1 in the posture for looking up at the LCD panel 22, that is the display unit. Specifically, the case that the screen of the apparatus in which the vertical direction is fixed is observed at the line of sight for forming the visual angle shown in FIG. 3B.

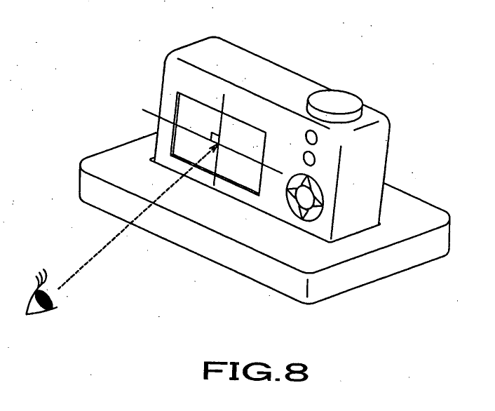

Furthermore, the content recorder/reproducer 1 is also used in the case that it is mounted in the cradle 81. The cradle 81 is inclined to a certain degree so that the user is easy to observe the display unit in the state that the content recorder/reproduce 1 is stationally installed. Therefore, in this case, the user is in the same posture as that the user looks up at the LCD panel 22 as shown in FIG. 8. This is the case that the screen of the apparatus in which the vertical direction is fixed is observed at the line of sight shown in FIG. 3B.

In the content recorder/reproducer 1 shown as the embodiment of the present invention, the system controller 12 discriminates the using mode and performs the process of changing the optimum view angle of the LDC panel 22 of the liquid crystal display device 100 through the image data controller 16 of the image processing unit 3.

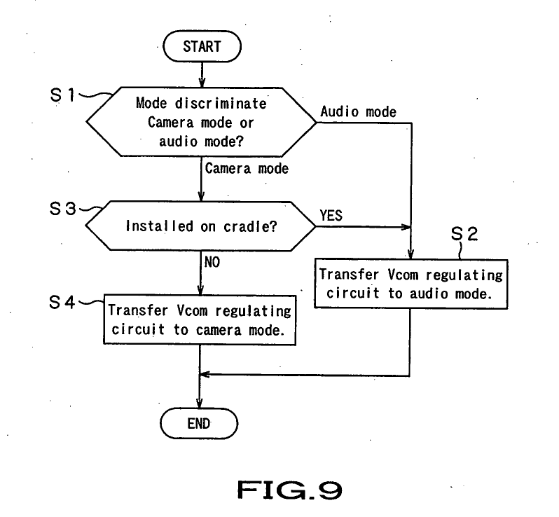

FIG. 9 shows the process of changing the view angle of the LCD panel 22 according to the mode by the content recorder/reproducer 1.

The system controller 12 of the content recorder/reproducer 1 firstly discriminates whether the content recorder/reproducer 1 is in the camera mode or the audio mode in step S1. At this time, the mode is discriminated according to setting of the device by the user or the opening/closing state of the lens cover 131. When the audio mode is selected, in step S2, the Vcom voltage value for acquiring the optimum view angle in the audio mode and other parameter for controlling the liquid crystal panel are read from the parameter memory 107. Then, the view angle characteristics of the liquid crystal panel is set to the audio mode.

Further, when the camera mode is selected in step S1, the system controller 12 discriminates whether the content recorder/reproducer 1 is installed on the cradle 80 in step S3. When the content recorder/reproducer 1 is installed on the cradle 80, as described above, even in the image display state, the user is in the same as that the user looks up at the LCD panel 22 as shown in FIG. 8. Therefore, the system controller 12 reads the Vcom voltage value for acquiring the optimum view angle in the audio mode and other parameter for controlling the liquid crystal panel from the parameter memory 107, and sets the view angle characteristics of the liquid crystal panel to the audio mode.

On the other hand, when it is found in step S3 that the content recorder/reproducer 1 is not installed in the cradle, the system controller 12 reads the Vcom voltage value for acquiring the optimum view angle in the camera mode and other parameter for controlling the liquid crystal panel from the parameter memory 107 in step S4, and sets the view angle characteristics of the liquid crystal panel to the camera mode.

The content recorder/reproducer 1 can change the view angle according to the mode as described above. Thus, the decrease of the visibility of the liquid crystal display unit due to the difference between the user's line of sight and the visual angle of the screen which occurs according to the mode of the content recorder/reproducer 1 can be prevented.

The above-mentioned embodiment is an example for explaining the present invention. The present invention can be applied to the electronic apparatus which has the liquid crystal display device as the display unit. Further, at this time, the visual field shifting direction may not be the vertical direction with respect to the apparatus. For example, in the apparatus necessary to observe the display unit from the different visual angle from right and left, the liquid crystal display device 1 may be provided in an apparatus main body which can change the visual angle to the direction for enabling the visual angle change in the right and left directions. Various changes and modifications of the electronic apparatus can be made within the scope of the subject matter of the present invention of changing the optimum view angle according to the using state or the finction of the electronic apparatus.

Incidentally, the description below will explain in detail the minidisk 90 which can be used in the content recorder/reproducer 1. As the minidisk 90, type that the modulation type of the conventional magnetooptical recording type is devised, and novel type that the concealability is improved and the high density of the recording capacity is realized by applying a signal type different from a recording format normally used as the recording/reproducing system of the minidisk adopting the conventional magnetooptical recording type, are listed. The novel type realizes the increase in the recording capacity while maintaining interchangeability among the conventional minidisk, a housing profile type and a recording/reproducing optical system by adopting a high density recording technology and a novel file system.

The specific example of the minidisk 90 will be hereinafter described. First, the specification of the conventional minidisk will be described.

The physical format of the conventional minidisk (and MD-DATA) is defined as follows. A track pitch is 1.6 μm, a bit length is 0.59 μm/bit. Further, a laser wavelength λ is λ=780 nm. The aperture ratio of the optical head is NA=0.45. As the recording type, a groove recording type used to record/reproduce the groove (groove on the disc surface) as a track is adopted. Further, an address type is a type forming a groove with a single spiral on the disc surface and utilizing a wobbled groove forming a wobble as address information at both sides of the groove. Incidentally, in the specification, an absolute address recorded as the wobble is also called an ADIP (Address in Pregroove). In the conventional minidisk, as the modulation type of the recording data, an EFM (8-14 conversion) modulation type is adopted. Furthermore, as an error correction type, an ACIRC (Advanced Cross Interleave Reed-Solomon Code) is used. Moreover, in a data interleave, a folding type is adopted. Thus, the redundancy of the data becomes 46.3%. Further, a data detection type in the conventional minidisk is a bit-by-bit type, and as the disc drive type, a CLV (Constant Linear Velocity) is adopted. The linear velocity of the CLV is 1.2 m/s. The standard data rate at recording/reproducing time is 133 kB/s, a recording capacity is 164 MB (MD-DATA, 140 MB). The minimum rewriting unit (cluster) of the data is constituted of 36 sectors by 32 main sectors and 4 link sectors.

On the contrary, among the minidisk 90 used in the specific example, the type (hereinafter referred, as needed, to as a first generation MD) which realizes a high recording density by changing the modulation type of the conventional magnetooptical recording type, has the same physical specifications of the above-mentioned conventional minidisk and the recording medium. A track pitch is 1.6 μm, a laser wavelength λ is λ=780 nm, an aperture ratio of the optical head is NA=0.45. As the recording type, a groove recording type is adopted. Moreover, as an address type, ADIP is used. Thus, the configuration of an optical system in the disc drive device, an ADIP address reading type, and a servo process are similar to those of the conventional minidisk. Accordingly, compatibility with the conventional disc is achieved. Further, the minidisk adopts, as a recording data modulation type, an RLL(1-7) PP modulation type (RLL: Run Length Limited, PP: Parity preserve/Prohibit rmtr (repeated minimum transition runlength) adapted to a high density recording. Furthermore, as the error correction type, an RS-LDC (Reed Solomon-Long Distance Code) type with a BIS (Burst Indicator Subcode) having higher correction capability is used. Moreover, the data interleave adopts a block completion type. Thus, the redundancy of the data becomes 20.50%. Further, the data detection type applies a Viterbi decoding type by a PR(1, 2, 1) ML.

In this case, the disc drive type similarly uses the CLV type and the linear velocity thereof is 2.4 m/s. The standard data rate at the recording/reproducing time is 4.4 MB/s. By adopting the type, a total recording capacity can be set to 300 MB. A window margin is set from 0.5 to 0.666 by adopting the modulation type from the EFM to the RLL(1-7)PP. Accordingly, high density of 1.33 times can be realized. Further, the cluster of the minimum rewriting unit of the data is constituted of 16 sectors, 64 kB. In this manner, the recording modulation type is changed from the CIRC type to the RS-LDC type with the BIS and type using the difference of the sector structure and Viterbi decoding. Thus, a data efficiency is improved from 53.7% to 79.5%. Accordingly, the increase of the density of 1.48 times can be realized. In total, recording capacity can be made to 300 MB of about twice as large as the conventional minidisk.

Further, the novel type that the improvement of the concealability and the high recording density are realized by applying the signal type different from the recording format normally used as the recording/reproducing type of the minidisk adopting the conventional magnetooptical recording type (hereinafter referred, as needed, to a second generation MD) is a recording medium applied with a high density recording technology, such as a domain wall displacement detection type (DWDD), and is different in the physical format from the conventional minidisk.

The novel type is a track pitch of 1.25 μm, a bit length of 0.16 μm/bit, and its increase of the density is in a linear direction. Further, to take compatibility with the conventional minidisk, the optical system, a reading type, a servo process and the like are constituted according to the conventional standards. The laser wavelength λ is λ=780 nm, and the aperture ratio of the optical head is NA=0.45. The recording type adopts a groove recording type. An address type is a type using ADIP. Further, a housing profile is the same standard as the conventional minidisk. However, when the track pitch narrower than the track pitch of the conventional minidisk and a linear density (bit length) are read by using the optical system equivalent to the conventional minidisk, it is necessary to eliminate restricting conditions in a track margin, a crosstalk from a land and groove, a crosstalk from wobble, a focus leakage, a CT signal and the like.

Therefore, in the minidisk 90, the groove depth, inclination, width, etc. of the groove are changed. More particularly, the groove depth is 160 to 180 nm, the inclination is 60 to 70°, and the width is 600 to 800 nm.

Further, in the novel type minidisk, as a recording data modulation type, an RLL(1-7)PP modulation type (RLL: Run Length Limited, PP: Parity preserve/Prohibit rmtr (repeated minimum transition runlength) conformed to the high density recording is adopted. Furthermore, as an error correction type, an RS-LDC (Reed Solumn-Long Distance Code) type with a BIS (Burst Indicator Subcode) having higher correction capability is used. The data interleave is a block completion type. Thus, the redundancy of the data becomes 20.50%. The data detection type adopts the Viterbi decoding type by a PR (1,−1) ML. Further, the cluster of the minimum rewriting unit of the data is constituted of 16 sectors, 64 kB.

As the disc drive type in this case, a ZCAV type is used. Its linear velocity is 2.0 m/s. The standard data rate at the recording/reproducing time is 9.8 MB/s. Thus, the novel type can set the total recording capacity to about 1 GB by adopting the DWDD type and the drive type.

It should be understood by those skilled in the art that various modifications, combinations, sub-combinations and alterations may occur depending on design requirements and other factors insofar as they are within the scope of the appended claims or the equivalents thereof.

1. A liquid crystal display device having a plurality of scanning lines and a plurality of signal lines provided by intersecting the scanning lines and having pixel capacitors including a pixel electrode, a common electrode and a liquid crystal layer, formed at intersecting portions of the plurality of the scanning lines and the plurality of the signal lines, the device comprising:
common voltage regulating means for supplying a common electrode voltage to the common electrode;
storage means for storing a parameter for generating a common electrode voltage value for obtaining a predetermined view angle distribution for every view angle; and
control means for controlling the common electrode voltage generated by the common voltage regulating means by selecting the parameter stored in the storage means.

2. A liquid crystal driving method for a liquid crystal display device having a plurality of scanning lines and a plurality of signal lines provided by intersecting the scanning lines and having pixel capacitors including a pixel electrode, a common electrode and a liquid crystal layer, formed at intersecting portions of the plurality of the scanning lines and the plurality of the signal lines, the method comprising:
a common voltage regulating step of supplying a common electrode voltage to the common electrode; and
a step of controlling the common electrode voltage generated in the common voltage regulating step by selecting a parameter necessary for generating common electrode voltage value for acquiring a predetermined view angle distribution from a memory stored in each view angle.

3. A content display device for a user to observe a video displayed on a display unit in a first operation mode and a second operation mode at a different angle, the device comprising:
detecting means for detecting an operation mode;
regulating means for regulating a view angle of the display unit; and
control means for controlling the regulating means so that the display unit adopts a predetermined view angle based on a detected result of the detecting means.

4. The content display device according to claim 3, wherein the content display device comprises operating means for setting the operation mode, and the detecting means detects the set operation mode.

5. The content display device according to claim 3, wherein
the content display device further comprises:
bonding means for bonding to a cradle for fixing the content display device at a predetermined angle; and the detecting means detects the bonding to the cradle.

6. The content display device according to claim 3, wherein
the content display device further comprises:
imaging means for imaging a video;
reproducing means for reproducing video recorded in a recording medium; and
operating means;
the control means controls to display the video inputted from the imaging means on the display unit when image pickup is instructed by the operating means, controls the regulating means so that it becomes a first visual field angle as the first operation mode, controls to display the video reproduced by the reproducing means on the display unit when reproduction of the video recorded on the recording medium is instructed by the operating means, and controls the regulating means so that it adopts a second visual field angle as the second operation mode.

7. The content display device according to claim 6, wherein the first operation mode is an angle for looking down at the display unit, and the second operation mode is an angle for looking up at the display unit.

8. A liquid crystal display device having a plurality of scanning lines and a plurality of signal lines provided by intersecting the scanning lines and having pixel capacitors including a pixel electrode, a common electrode and a liquid crystal layer, formed at intersecting portions of the plurality of the scanning lines and the plurality of the signal lines, the device comprising:
a common voltage regulating unit that supplies a common electrode voltage to the common electrode;
a storage unit that stores a parameter for generating a common electrode voltage value for obtaining a predetermined view angle distribution for every view angle; and
a control unit that controls the common electrode voltage generated by the common voltage regulating unit by selecting the parameter stored in the storage unit.

9. A content display device for a user to observe a video displayed on a display unit in a first operation mode and a second operation mode at a different angle, the device comprising:
a detecting unit that detects an operation mode;
a regulating unit that regulates a view angle of the display unit; and
a control unit that controls the regulating unit so that the display unit adopts a predetermined view angle based on a detected result of the detecting unit.
